(19) United States
(12) Patent Application Publication
(10) Pub. No.: US 2022/0174966 A1
(43) Pub. Date: Jun. 9, 2022

(54) Gingerbread Structure Incorporating Support Structure and Packaged Kit for the Decoration Thereof

(71) Applicant: BRAND CASTLE LLC, Bedford Heights, OH (US)

(72) Inventor: James E. Zeilinger, Shaker Heights, OH (US)

(21) Appl. No.: 17/546,899

(22) Filed: Dec. 9, 2021

Related U.S. Application Data
(60) Provisional application No. 63/123,432, filed on Dec. 9, 2020.
(60) Provisional application No. 63/225,907, filed on Jul. 26, 2021.

(51) Int. Cl. A21D 13/48; A63H 33/04; A21D 13/47; A63H 33/14

(52) U.S. Cl. CPC A21D 13/48; A63H 33/14; A21D 13/47; A63H 33/044

(57) ABSTRACT

A gingerbread structure includes at least first and second gingerbread cookie panels, and a box-like support structure that includes at least first and second side panels that meet at an angle at a corner, wherein: inner surfaces of the first and second gingerbread cookie panels are adhered to flat surfaces of the first and second side panels by first and second amounts of edible icing in orientations that cause side edges of the first and second gingerbread cookie panels to extend adjacent to and parallel to the corner; and to extend adjacent to and parallel to each other to enable the side edges to be adhered to each other by depositing a third amount of edible icing along and therebetween.

### REFERENCE TO PROVISIONAL APPLICATION

This application is related to, and claims the benefit of the filing dates of, U.S. Provisional Application Serial No. 63/123,432 (Atty's Docket No. 7-540) filed Dec. 9, 2020 by James E. Zeilinger; and U.S. Provisional Application Ser. No. 63/225,907 (Atty's Docket No. 7-541) filed Jul. 26, 2021 by James E. Zeilinger; the disclosures of both of which are incorporated herein by reference.

### BACKGROUND

The present invention relates to gingerbread houses or other gingerbread structures formed from decorated, baked gingerbread cookies that are each sized and configured to define a gingerbread wall, roof, or other structural component. The present invention also relates to the pre-performance of a selected subset of the assembly and/or decoration steps involved in the creation of gingerbread houses or other gingerbread structures to enhance the experience of assembly and/or decoration by an end customer.

It has long been known to construct small house-like structures from flat pieces of gingerbread of uniform thickness that have perimeter configurations designed to form the upstanding wall components of a one-room house that, once erected by using lines of icing to connect and bond adjacent components, can be overlaid by inclined roof components that give the one-room house a simulated roof.

It has also been known to prepare flat pieces of gingerbread having more elaborate perimeter configurations that, when assembled, define structures that are more complex than a simple one-room house—with such structures having, for example, upstanding walls that can extend to a variety of heights, lengths or widths, and may be overlaid by flat or inclined roof components that add interesting complexity to the newly formed structures.

It is generally desirable for gingerbread structures to be relatively elaborately decorated, with decorations in colored icing, candy, or other media, the decorations representing doors, windows, roof shingles, and a variety of Christmas decorations, such as lights, wreaths, Christmas trees, and the like.

Producing such elaborate decorations typically requires at least some degree of skill and artistic ability, which may be lacking in children and others who might, nonetheless, enjoy constructing and decorating gingerbread structures. It would, therefore, be desirable to provide systems and methods that permit even unskilled bakers and decorators to produce display-worthy gingerbread structures.

### SUMMARY

What is disclosed herein includes gingerbread structures (e.g., gingerbread houses) that are assembled from gingerbread cookies with the assistance of a support structure, and packaged kits for decorating such gingerbread structures.

A gingerbread structure includes: at least a first gingerbread cookie panel and a second gingerbread cookie panel; at least a first amount of edible icing, a second amount of edible icing, and a third amount of edible icing; and a box-like support structure including at least a first side panel and a second side panel that are integrally formed together. The first side panel provides a first flat surface; the second side panel provides a second flat surface; the first side panel and the second side panel join at a first fold that defines a corner along which the first flat surface and the second flat surface meet at an angle; an inner surface of the first gingerbread cookie panel is adhered to the first flat surface of the first side panel by the first amount of edible icing in an orientation relative to the first flat surface that causes a first side edge of the first gingerbread cookie panel to extend adjacent to and parallel to the corner; and an inner surface of the second gingerbread cookie panel is adhered to the second flat surface of the second side panel by the second amount of edible icing in an orientation relative to the second flat surface that causes a second side edge of the second gingerbread cookie panel to extend adjacent to and parallel to the corner, and to extend adjacent to and parallel to the first side edge of the first gingerbread cookie panel to enable the second side edge to be adhered to the first side edge by depositing the third amount of edible icing along and between the first side edge and the second side edge.

A kit for at least decorating a gingerbread structure includes: a box-like carton having at least four side faces and a bottom face; a base support sheet providing an upwardly facing support surface; and a box-like support structure including at least a first side panel and a second side panel that are integrally formed together. The first side panel provides a first flat surface; the second side panel provides a second flat surface; the first side panel and the second side panel join at a first fold that defines a corner along which the first flat surface and the second flat surface meet at an angle; an inner surface of a first gingerbread cookie panel of the gingerbread structure is adhered to the first flat surface of the first side panel by a first amount of edible icing in an orientation relative to the first flat surface that causes a first side edge of the first gingerbread cookie panel to extend adjacent to and parallel to the corner; an inner surface of the second gingerbread cookie panel is adhered to the second flat surface of the second side panel by a second amount of edible icing in an orientation relative to the second flat surface that causes a second side edge of the second gingerbread cookie panel to extend adjacent to and parallel to the corner, and to extend adjacent to and parallel to the first side edge of the first gingerbread cookie panel to enable the second side edge to be adhered to the first side edge by depositing the third amount of edible icing along and between the first side edge and the second side edge; either a downwardly facing flat surface of the box-like support structure is adhered to the upwardly facing support surface, or the box-like support structure is formed integrally with the base support sheet; the upwardly facing surface of the base support sheet caries decorative markings that define a pre-selected part of the upwardly facing support surface as being a support region to guide placement of at least the box-like support structure, with at least both of the first gingerbread cookie panel and the second gingerbread cookie panel adhered thereto, onto the support region; the base support sheet is shaped and sized to be placed inside the carton sitting flat atop the bottom face while engaging the four side faces to prevent movement of the base support sheet toward or away from each of the four side faces; the support region is defined to cause the gingerbread structure to be positioned on the base support sheet at a location away from contact with any of the at least four side faces; and the support structure, the base support sheet and the carton cooperate to keep the gingerbread structure away from contact with any of the at least four side faces to protect the gingerbread structure from damage caused by impacts against any of the at least four side faces.

### BRIEF DESCRIPTION OF THE DRAWINGS

A fuller understanding of what is disclosed in the present application may be had by referring to the description and claims that follow, taken in conjunction with the accompanying drawings, wherein:

FIG. 1A is an exploded perspective view of embodiments of both a gingerbread structure incorporating embodiments of a support structure and base support sheet to aid in the assembly thereof, and an embodiment of a packaged kit incorporating various edible decorative elements for use in decorating such a gingerbread structure;

FIG. 1B is an exploded perspective view of the gingerbread structure embodiment of FIG. 1A depicting aspects of the assembly thereof onto the support structure and base support sheet embodiments of FIG. 1A;

FIG. 1C is a sectional view of a section taken vertically through the embodiments of the gingerbread structure, the support structure and base support sheet of FIGS. 1A-B, with the gingerbread structure assembled onto the support structure and base support sheet of FIGS. 1A-B;

FIG. 2A is an elevational view of an embodiment of a gingerbread cookie shaped, sized and/or otherwise configured to serve as a panel of a roof of an alternate embodiment of gingerbread structure;

FIG. 2B is a sectional view of a section taken vertically through the alternate embodiment of the gingerbread structure of FIG. 2A, with the alternate embodiment of the gingerbread structure assembled onto the embodiments of the support structure and base support sheet of FIGS. 1A-C;

FIG. 2C is an elevational view of an embodiment of a gingerbread cookie shaped, sized and/or otherwise configured to serve as a panel of a “front” wall of either the gingerbread structure embodiment of FIGS. 1A-C, or the alternate gingerbread structure embodiment of FIGS. 2A-B;

FIG. 2D is an elevational view of an embodiment of a gingerbread cookie shaped, sized and/or otherwise configured to serve as a panel of a “back” wall of either the gingerbread structure embodiment of FIGS. 1A-C, or the alternate gingerbread structure embodiment of FIGS. 2A-B;

FIG. 3A is an elevational view of an embodiment of the support structure of FIGS. 1A-C, as well as FIG. 2B, with the support structure in an unassembled state;

FIG. 3B is an elevational view of an embodiment of an illumination component of the gingerbread structure embodiments of FIGS. 1A-C and 2A-B, with the illumination component in an unassembled state;

FIG. 4A is an elevational view of an embodiment of the base support sheet of FIGS. 1A-C, as well as FIG. 2B, with the base support sheet in an unfolded state; and

FIG. 4B is a perspective view of a box of the packaged kit embodiment of FIG. 1A.

### DETAILED DESCRIPTION

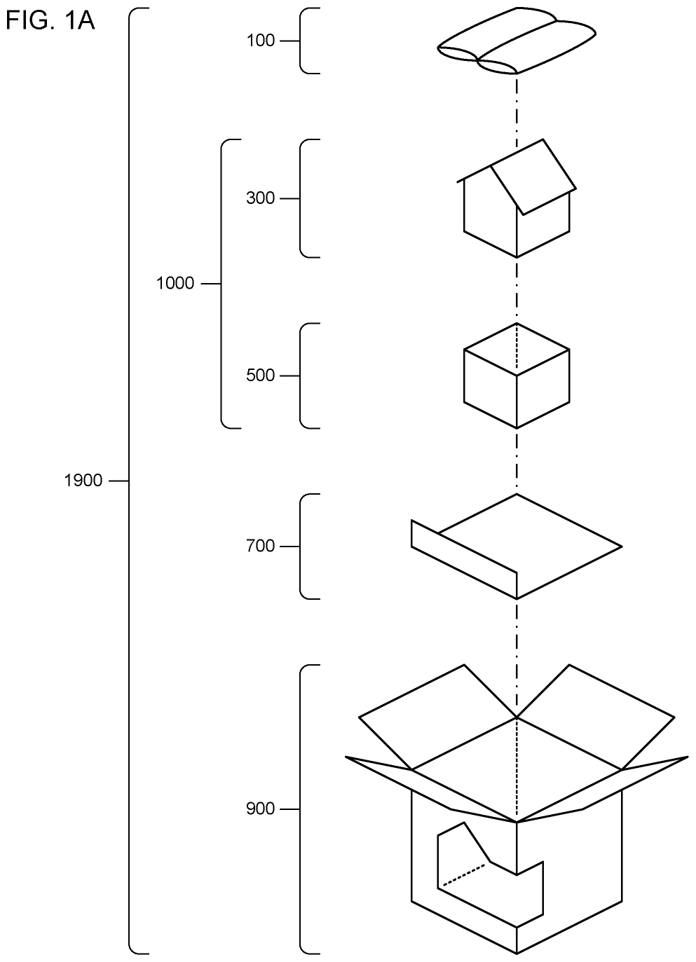

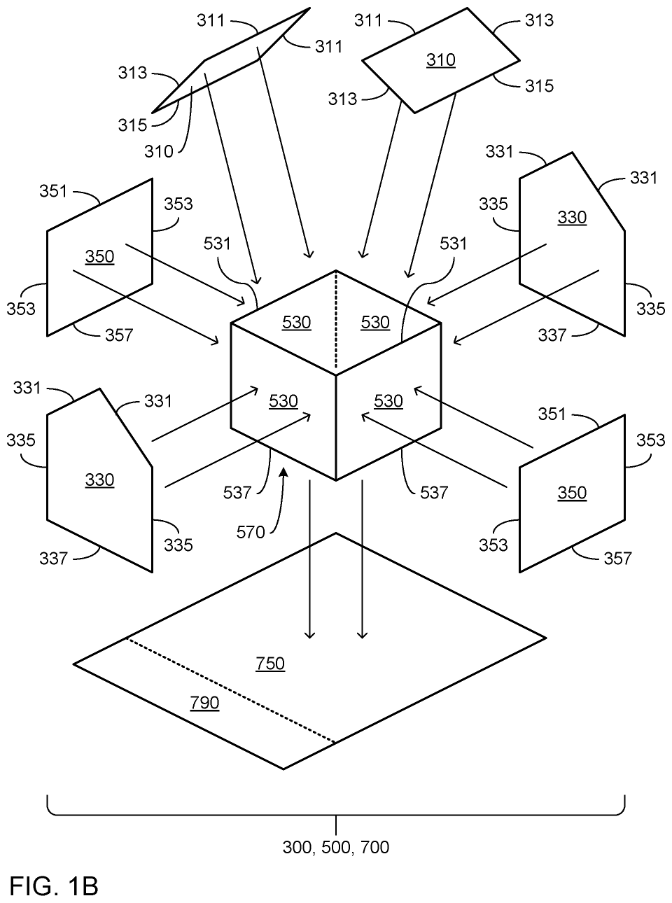

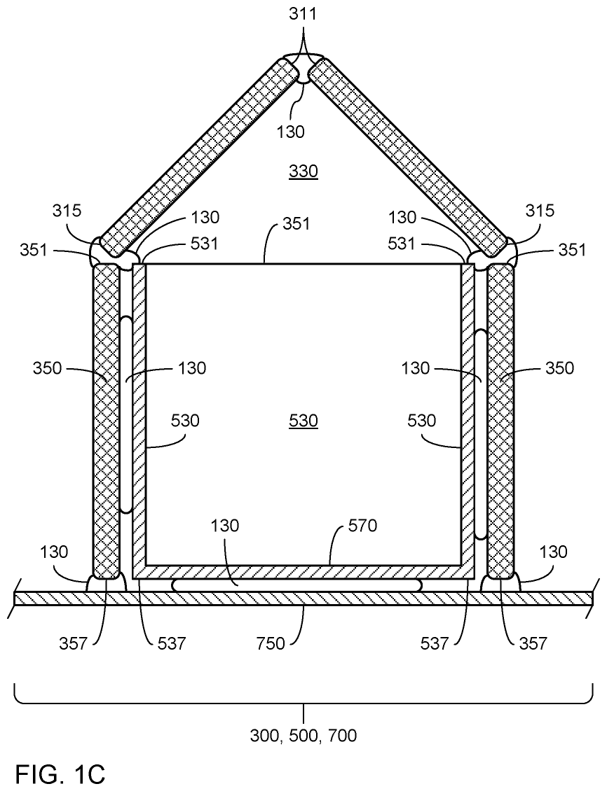

FIGS. 1A through 1C, taken together, depict various aspects of a novel gingerbread structure 1000 that addresses many of the shortcomings of prior art gingerbread structures, and a packaged kit 1900 to enable at least the shipment and decoration thereof. More specifically, in various embodiments discussed and depicted herein, a set of pre-baked gingerbread cookie panels 310, 330 and 350 may be assembled to form portions of a gingerbread core 300 of the gingerbread structure 1000 (e.g., a gingerbread house). Also, in various embodiments discussed and depicted herein, the gingerbread structure 1000, in an at least partially assembled form, may be shipped in a shipping carton 900 as part of the packaged kit 1900.

It should be noted that, despite references to “gingerbread” throughout the present application as an edible cookie material that may be used, other embodiments are possible in which other varieties of pre-baked cookies (e.g., sugar cookies, shortbread, etc.) may be used, either in addition to or in lieu of gingerbread. Therefore, for purposes of the present application, such terms as “gingerbread house”, “gingerbread structure”, “gingerbread cookie”, “gingerbread panel” and/or “gingerbread cookie panel” are used herein regardless of the actual type of cookie used (i.e., regardless of the actual type of edible cookie material that is used).

In some embodiments, a set of such gingerbread cookie panels may be pre-baked and sold together as a kit in which they may have been pre-assembled to form at least the gingerbread core 300 of the gingerbread structure 1000 (e.g., as part of the packaged kit 1900). Thus, in such embodiments, the gingerbread structure 1000 may be in a ready-to-decorate form. In other embodiments, a set of such gingerbread cookie panels may be pre-backed and sold together as a kit, but not pre-assembled. In still other embodiments, ingredients and/or instructions for making a set of such gingerbread cookie panels may be sold as a kit.

Each of these differing embodiments of a kit may or may not include one or more packets 100 of edible decorative elements, such as edible icing 130 (e.g., white icing such as royal icing, and/or icing of any of a variety of holiday-related colors, such as red and/or green). As is about to be described In some detail, at least the gingerbread core 300 of the gingerbread structure 1000 may be assembled, or pre-assembled, using the edible icing 130 applied at edges and/or on surfaces of the gingerbread cookie panels 310, 330 and/or 350. However, the one or more packets 100 of edible decorative elements may also include candy for decorating the gingerbread structure 1000, and/or other playful food-based decorating elements, such as edible glitter, colored sugar, sprinkles, jimmies, dragees, nonpareils, and the like.

Turning to FIG. 1A, at a minimum, assembly of the gingerbread core 300 may entail adhering inner surfaces of at least the gingerbread cookie panels 330 and 350 directly to external surfaces of upstanding side panels 530 of a support structure 500, followed by adhering the gingerbread cookie panels 310 to various edges of the gingerbread cookie panels 330 and 350, as will shortly be described in greater detail. However, such assembly of the gingerbread core 300 may also entail adhering at least a downwardly facing surface of a bottom panel 570 of the support structure 500 to an upwardly facing surface of a main portion 750 of a base support sheet 700.

Turning to FIGS. 1B-C, such adherence of the gingerbread cookie panels 330 and 350 of the gingerbread core 300 to the side panels 530 of the support structure 500 may be entail the use of small amounts of the edible icing 130 taken from the one or more packets 100 of edible decorative elements. As depicted, such use of the edible icing 130 may entail simply smearing small amounts onto the external surfaces of the side panels 530 and/or onto the inner surfaces of the gingerbread cookie panels 330 and 350, followed by pressing the gingerbread cookie panels 330 and 350 against the side panels 530 with the smeared-on small amounts of the edible icing 130 interposed therebetween in a manner that may be somewhat akin pressing tile onto a wall surface with amounts of grout interposed therebetween. It should be noted that, for ease of illustration and understanding, the thickness of such small amounts of the edible icing 130 has been deliberately exaggerated to make the edge-on view of the edible icing more visually discernable.

More specifically, each of the gingerbread cookie panels 350 (which may each form a side face of the gingerbread structure 1000) may be adhered to opposing ones of the side panels 530 of the support structure 500 in an orientation that causes corner edges 353 of the gingerbread cookie panels 350 to extend vertically, as well as adjacent to and parallel with corners at which pairs of the side panels 530 meet at right angles. Such an orientation of the gingerbread cookie panels 350 may also cause upper edges 351 thereof to extend horizontally, as well as adjacent to and parallel with upper edges 531 of the opposing ones of the side panels 530 of the support structure 500.

Similarly, each of the gingerbread cookie panels 330 (which may each form one of a front face and a rear face of the gingerbread structure 1000) may be adhered to one of the other two opposing side panels 530 of the support structure 500 in an orientation that causes corner edges 335 of the gingerbread cookie panels 330 to also extend vertically, as well as adjacent to and parallel with corners at which pairs of the side panels 530 meet at right angles. In this way, pairs of the corner edges 335 of the gingerbread cookie panels 330 and the corner edged 353 of the gingerbread cookie panels 350 are also caused to extend adjacent to and parallel with each other. Such an orientation of the gingerbread cookie panels 330 may also cause pairs of upper edges 331 thereof to extend upwardly at angles meeting at upwardly extending peaks.

With the gingerbread cookie panels 330 and 350 so adhered to the support structure 500, amounts of the edible icing 130 may then be deposited along, and into the vertically extending gaps between, each of the pairs of cover edges 335 and 353 that cooperate to define corners of the gingerbread structure where each of the front and rear faces meet the side faces. It is important to note that the provision of the support structure 500, with its set of side walls 530 providing such surfaces for the adhesion of the gingerbread cookie panels 330 and 350 thereto (as has been described) serves to make the assembly of at least the gingerbread core 300 of the gingerbread structure 1000 considerably easier. Specifically, the support structure 500 serves to eliminate one of the greatest challenges of creating such gingerbread structures, which is holding two or more vertically oriented gingerbread cookie panels together in their desired relative positions while also applying edible icing to bond them together. Eliminating this challenge may make the building of gingerbread structures a less frustrating activity for customers buying gingerbread structures in unassembled form, and/or may increase the efficiency with which gingerbread structures may be built by paid workers for retail sale (e.g., as part of kits, such as the packaged kit 1900).

Also with the gingerbread cookie panels 330 and 350 so adhered to the support structure 500, amounts of the edible icing 130 may then be deposited along the lengths of the upper edges 331 and 351 thereof, respectively. As best seen in FIG. 1C, it may be that each of the amounts of the edible icing 130 that are deposited along one of the upper edges 351, may also be partially deposited along an adjacent one of the upper edges 531 of one of the side panels 530 of the support structure 500.

With those amounts of the edible icing 130 so deposited along the upper edges 331 and 531 of the gingerbread cookie panels 330 and 530, respectively, each one of the two gingerbread cookie panels 310 (which may each form a portion of a roof of the gingerbread structure 1000) may be adhered to one of two different sets of upper edges 331 and 531 that are each provided by a different combination of the gingerbread cookie panels 330 and 530. More specifically, a lower edge 315 and a pair of side edges 313 of one of the gingerbread cookie panels 310 may be adhered to an upper edge 351 of one of the gingerbread cookie panels 350, and to an adjacent one of the upper edges 331 of each of the gingerbread cookie panels 330. Correspondingly, a lower edge 315 and a pair of side edges 313 of the other of the gingerbread cookie panels 310 may be adhered to the other upper edge 351 of the other one of the gingerbread cookie panels 350, and to a different one of the upper edges 331 of each of the gingerbread cookie panels 330. Such orientations of the two gingerbread cookie panels 310 may cause upper edges 311 of each to extend horizontally, as well as adjacent to and parallel with each other.

With the gingerbread cookie panels 310 so adhered to the upper edges 331 and 351 of the gingerbread cookie panels 330 and 350, respectively, an amount of the edible icing 130 may then be deposited along, and into the horizontally extend gap between, the pair of upper edges 311 that cooperate to define the peak of the roof of the gingerbread structure where the two gingerbread cookie panels 310 meet. It is important to note that the provision of the support structure 500, with its set of walls 530 providing surfaces for the adhesion of the gingerbread cookie panels 330 and 350 thereto, serves to ensure that the gingerbread cookie panels 330 and 350 are highly unlikely to move relative to each other as the gingerbread cookie panels 310 are adhered to the upper edges 331 and 351, respectively, thereof. Specifically, the support structure 500 serves to eliminate one of the other of the greatest challenges to creating such gingerbread structures, which keeping the vertically oriented gingerbread cookie panels in place as the gingerbread cookie panels that provide the roof are adhered thereto. The need to apply some small amount of pressure to press the gingerbread cookie panels that provide the roof into the edible icing placed along upper edges of the vertically oriented panels can quite easily cause the vertically oriented panels to move relative to each other, and thereby collapse the portion of the gingerbread structure that was already successfully assembled.

The amount of surface area available between the external surface of each of the side panels 530 of the support structure 500 and the inner surface of a corresponding one of each of the gingerbread cookie panels 330 and 350 is significantly greater than the amount of surface area between each of the adjacent pairs of side edges 335 and 353. The significantly greater surface areas between the external surface of each of the side panels 530 and the inner surface of a corresponding one of each of the gingerbread cookie panels 330 and 350 permits significantly more of the edible icing 130 to be used in adhering each of the gingerbread cookie panels 330 and 350 to one of the side panels 530 of the support structure. As a result, each of the gingerbread cookie panels 330 and 350 is provided with significantly greater adhesion to one of the side panels 530 than is able to be provided directly between adjacent pairs of the cookie panels 330 and 530 using the edible icing 130 at the corners defined by where adjacent pairs of the side edges 335 and 353 meet.

With the gingerbread core 300 having been fully assembled as just described, additional amounts of the edible icing 130 may be used to adhere the assembled gingerbread core 300 to part of the upwardly facing support surface of a main portion 750 of the base support sheet 700. More specifically, and as best seen in FIG. 1C, an amount of the edible icing 130 may be deposited between the base support sheet 700 and a downwardly facing surface of the bottom panel 570 of the support structure 500, and/or further amounts of the edible icing 130 may be deposited between the base support sheet 700 and bottom edges 337 and 357 of the gingerbread cookie panels 330 and 350, respectively. With such amounts of the edible icing 130 so deposited, the assembled gingerbread core 300, along with the support structure 500, may then be adhered to the upwardly facing surface of the main portion 750 of the base support sheet 700.

However, it should also be noted that, in other embodiments, the bottom panel 570 of the support structure 500 may be so adhered to the upwardly facing surface of the main portion 750 of the base support sheet 700 prior to assembly of the gingerbread core 300 via adherence of the gingerbread cookie panels 330 and 350 to the side panels 530, as just described above. By way of example, and as will shortly be explained, in some embodiments, the support structure 500 may be formed integrally with the base support sheet 700 such that they are, together, a single structure. Also by way of example, a builder of the gingerbread structure 1000 may be provided with instructions to choose an orientation of at least a portion of the support structure 500 relative to the base support sheet 700 that may, in so doing, effect a choice of decorative printing that may be visible through apertures formed through gingerbread cookie panels 330 and/or 350 that define one or more windows of the gingerbread structure 1000.

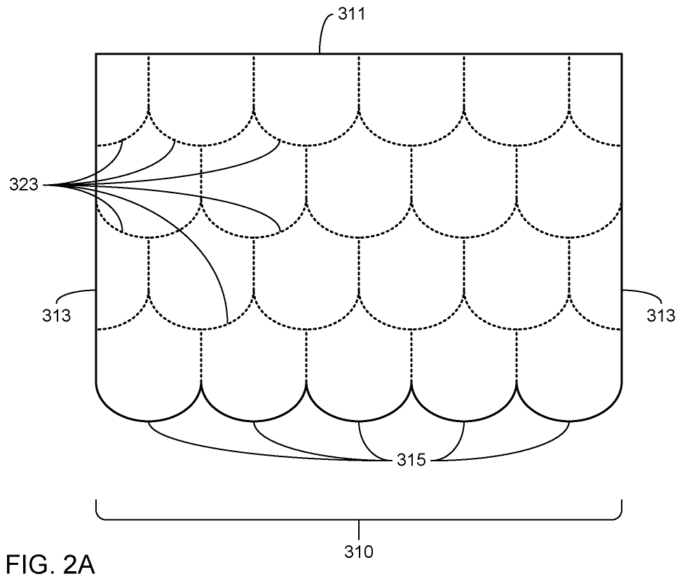

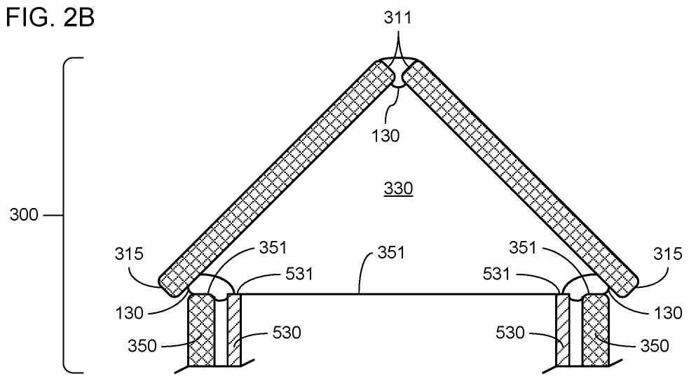

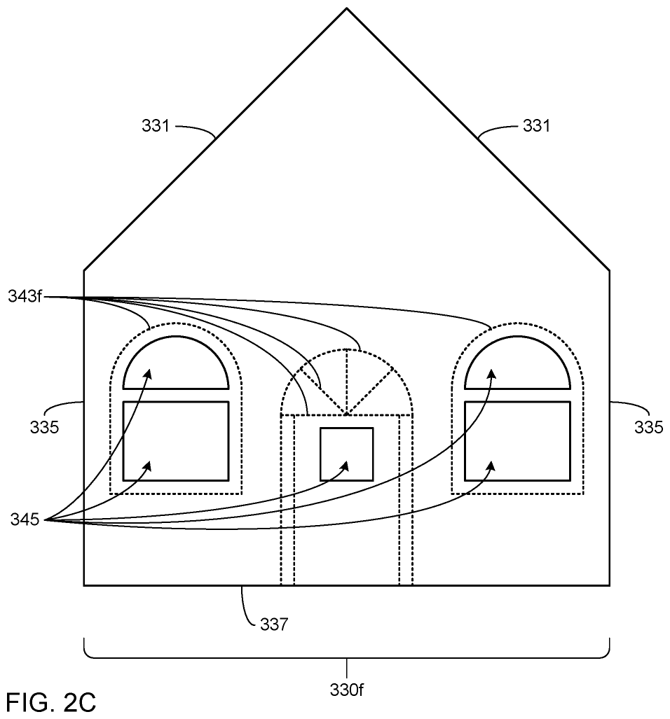

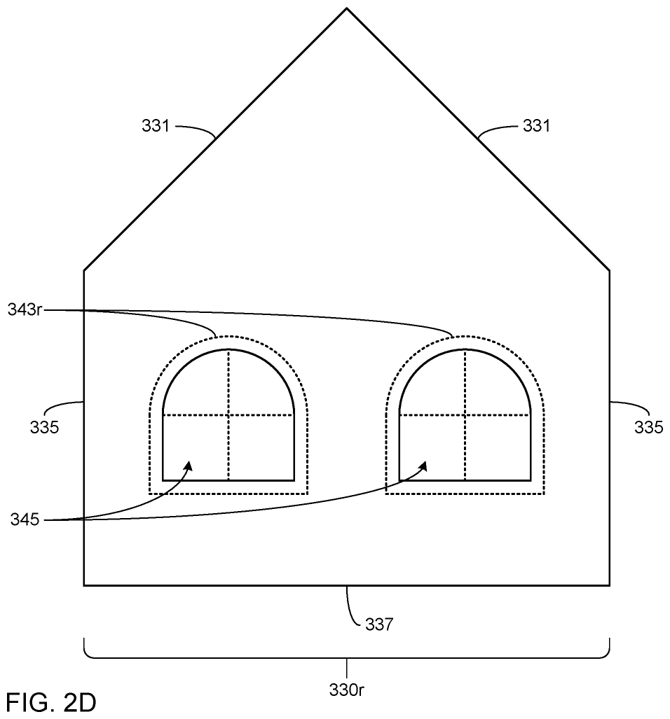

FIGS. 2A through 2D, taken together, depict various aspects of embodiments of at least the gingerbread cookie panels 310 and 330 in greater detail. More specifically, different ones of the gingerbread cookie panels 310, 330 and/or 350 may be pre-decorated with decorative features and/or guides for the application of decorative features, using grooves, embossing, debossing, edible ink etc. These decorative features may serve directly as decorations for the exterior of the gingerbread house or structure, and/or may serve as visual guides for the application of the edible icing 130, candy or other (preferably edible) decorative elements that may be used to decorate the exterior surfaces of the gingerbread structure 1000. Again, such decorative elements may be among those provided in the one or more packets 100 of decorative elements, which may also provide the edible icing 130.

The decorative features may depict a variety of conventional external features of houses or other structures, such as a door or door opening; a window or window opening; wall or roof covering materials such as siding, weatherboard, shingles; and/or structural members such as stone, brick, or concrete members. Other external features such as a chimney, fences (white-picket, wrought iron or other varieties), railings, light fixtures, trees or other plants, or other conventional features (often of Victorian-era, “old-world,” or country cottages, houses, or structures) may also be depicted in the imprinted decorative features. Alternatively or additionally, assorted Christmas decorations may be depicted, including items such as Christmas lights, candles, wreathes, bows, garlands, Christmas trees, ornaments, nutcrackers, nativity scenes, stockings, poinsettias, Santa Clause, elves, reindeer, bells, stars, holly, candy canes, angels, wrapped gifts, snow, icicles, and other Christmas and winter imagery. Additionally, traditional indoor Christmas imagery may appear in the window or doorway imagery of the imprinted decorative features, including imagery depicting, for example, a Christmas tree, a fireplace, wrapped gifts, stockings, candles, and so on. In some implementations, the decorative features may depict a sign or banner, which may display a Christmas-appropriate message, such as “Santa's Workshop”, “Merry Christmas”, etc. It should further be noted that in some implementations, messages or imagery associated with other faith-traditions, such as Hanukkah-specific images (e.g., menorahs, stars, candles, dreidels, chocolate gelt, blue and white/silver colors, etc.) may be used.

FIGS. 2A-B, taken together, depict aspects of an alternate embodiment of the gingerbread cookie panels 310 that are depicted in FIGS. 1A-C. More specifically, unlike the more simply rectilinear embodiment of the gingerbread cookie panels 310 depicted in FIGS. 1A-C, at least the lower edge 315 of the embodiment of the gingerbread cookie panels 310 of FIGS. 2A-B has a more complex shape that is meant to resembled curved edge portions of roof shingles in a manner that picks up the curved edge shingle markings 323. As previously discussed, such shingle markings 323 may be formed on an external surface of each of the gingerbread cookie panels 310 via embossing, debossing, as carved grooves and/or as printed-on markings using edible ink.

The more irregularly shaped lower edge 315 of the embodiment of the gingerbread cookie panels 310 of FIGS. 2A-B may necessitate a change in the manner in which the gingerbread core 300 is assembled. More specifically, and as best seen in FIG. 2B, it may be that such an embodiment of the gingerbread cookie panels 310 are meant to be adhered onto the gingerbread cookie panels 330 and 350 in a manner in which the lower edge 315 is not involved. Instead, the upper edge 351 of each of the gingerbread cookie panels 350 may be caused to be adhered to an inner surface of a corresponding one of the gingerbread cookie panels 350 using the edible icing 130, thereby allowing the lower edge 315 to extend further outward and downward from the vicinity of the upper edge 351 such that the edges 315 and 351 may not meet.

FIGS. 2C-D, taken together, depict aspects of example embodiments of the gingerbread cookie panels 330, including a gingerbread cookie panel 330f that may be decorated to present an appearance of a front face of the gingerbread structure 1000 (including what may be regarded as being a front door and windows), and a gingerbread cookie panel 330r that may be decorated to present an appearance of a rear face of the gingerbread structure 1000 (including what may be regarded as windows). As previously discussed, various decorative markings 343f and 343r meant to resemble door(s) and/or window(s) may be formed on external surfaces of the gingerbread cookie panels 330f and 330r, respectively, using edible ink, embossing, debossing, carved grooves, etc.

However, other example embodiments are possible in which one or more apertures 345 may be formed through one or more gingerbread cookie panels (e.g., the depicted example gingerbread cookie panels 330f and/or 330r), where each such aperture 345 may be sized, shaped and/or otherwise configured to resemble such features as a window, a door or a window formed through a door. More specifically, as shown in FIG. 2C as an example, five of such apertures 345 may be formed through the gingerbread cookie panel 330f to resemble pairs of window panes for two windows and a smaller window of a door. Similarly, as shown in FIG. 2D as an example, two of such apertures 345 may be formed through the gingerbread cookie panel 330r to resemble two windows.

As will shortly be explained in greater detail, in some embodiments, the formation of such apertures 345 through one or more gingerbread cookie panels 310, 330 and/or 350 may enable the use of lighting provided from within the gingerbread core 300 and/or from within the support structure 500 within the gingerbread core 300 to shine out through such apertures 345. Within such apertures 345, translucent material may be positioned for such light to illuminate, and such translucent material may carry various printings and/or other markings thereon that become backlit by such light to provide depictions of interior scenery of the gingerbread structure 1000.

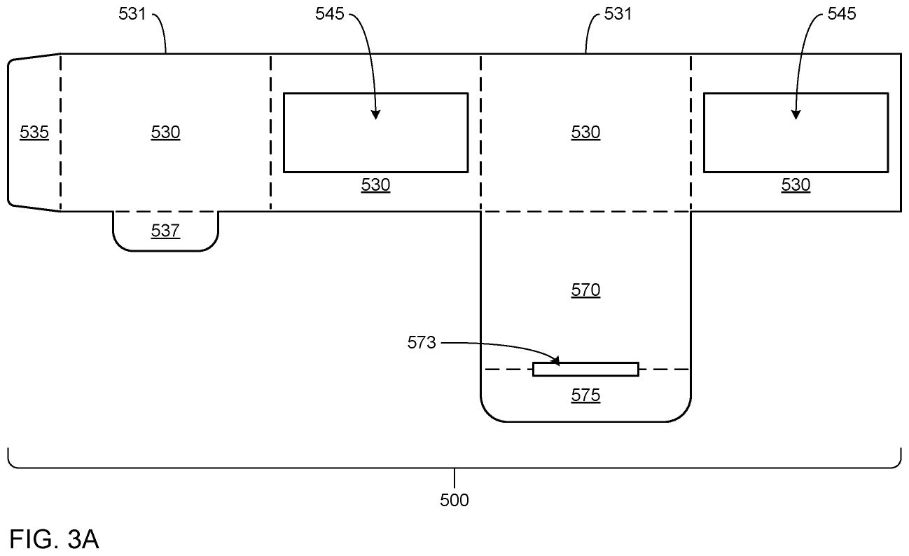

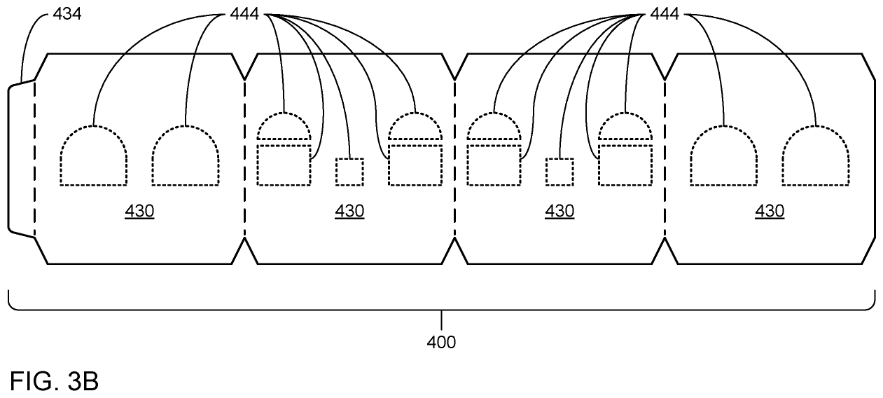

FIGS. 3A through 3B, taken together, depict various aspects of embodiments of the support structure 500 in greater detail. As those skilled in the art will readily recognize, the generally box-like shape of the support structure 500 lends itself to being formed in any of a variety of ways by which shipping and/or storage boxes are often formed.

Turning to FIG. 3A, by way of example, an embodiment of the support structure 500 may be formed by cutting a complex two-dimensional shape from a sheet of cardboard or other flat material, and then folding that complex two-dimensional shape to create at least a three-dimensional box-like shape. Such a complex two-dimensional shape may define one or more tabs (e.g., one or more of the depicted tabs 535, 537 and/or 575), slots (e.g., the depicted slot 573), hooks, etc. that are meant to interlock, be glued together and/or interact in other ways to cause the three-dimensional box-like shape of the support structure 500 to be maintained after it has been formed. Such a complex two-dimensional shape may be folded at various locations (which may be marked in various ways, and/or pressed or scored using various techniques to make folding thereat easier) that begin to impart the intended three-dimensional box-like shape, and that cause the various tags, slots, hooks, etc. to be brought together to enable their intended interaction(s).

Thus, for the example of a complex two-dimensional shape depicted in FIG. 3A, it may be that forming the intended three-dimensional box-like shape begins with folding the complex two-dimensional shape at the six locations indicated with dashed lines, thereby more clearly defining the four side panels 530 and the bottom panel 570. Such folding also serves to bring the depicted example tab 535 at one end of the depicted row of side panels 530 into engagement with the one of the side panels 530 at the opposite end of that row to thereby enable gluing and/or another interaction therebetween. Such folding further serves to bring the depicted example tab 537 extending from one of the side panels 530 into engagement with the depicted example slot 573 to thereby enable an interlocking interaction and/or another interaction therebetween. In this way, the support structure 500 with the four side panels 530 and the single bottom panel 570 may be formed.

As previously discussed in detail, once formed, each of the externally facing surfaces of the side panels 530 defined by the three-dimensional box-like shape of the support structure 500 may provide a relatively flat surface to which the inner surface of one of the gingerbread cookie panels 330 or 350 may be adhered using the edible icing 130, or another edible substance that is amenable to being used, at least briefly, as an adhesive. In some embodiments, such externally facing surfaces of the support structure 500 and/or such inner surfaces of the gingerbread cookie panels 330 and/or 350 may be formed to be textured to enhance the ability of the edible icing 130 to effect such adhesion. Again, in this way, such a support structure may aid in resolving one of the more vexing problems often encountered in building a gingerbread structure, which is keeping the gingerbread cookie panels meant to serve as walls in a vertical orientation while their edges are being connected and bonded together with icing.

Turning to FIG. 3B in addition to FIG. 3A, in some embodiments, the support structure 500 may additionally incorporate an illumination component 400 that may also be formed as a complex two-dimensional shape that may also define one or more tabs, slots, hooks, etc. that are meant to interlock, be glued together and/or interact in other ways in a manner similar to what has been described in reference to the support structure 500, itself. When folded at various locations (indicated with four dashed lines), a three-dimensional box-like shape defining four side panels 430 may begin to be formed, with the depicted example tab 434 at one end of the depicted row of side panels 430 being brought into engagement with a portion of the side panel 430 at the opposite end of that row for being glued together (and/or for being caused to interact with each other in some other way).

Once the illumination component 400 has been given its box-like shape, it may be positioned within the box-like shape of the support structure 500 in a manner that positions each of the side panels 430 of the illumination component 400 against and in parallel with a corresponding one of the side panels 530 of the support structure 500. More specifically, as depicted in FIG. 3A, one or more of the side panels 530 of the support structure 500 may have one or more apertures 545 formed therethrough. Each such aperture may be shaped, sized and/or positioned within one of the side panels 530 so as to be overlapped by one or more apertures 345 (best seen in FIGS. 2C and 2D) that may be formed through one of the gingerbread cookie panels 330 or 530. Further, as depicted in FIG. 3B, one or more of the side panels 430 of the illumination component 400 may carry decorative markings 444 meant to provide fictional depiction(s) of the interior of the gingerbread structure 1000. Such decorative markings 444 may be shaped, sized and/or positioned on one or more of the side panels 430 of the illumination component 400 to closely align with the shape, size and/or position of one or more apertures 345 that may be formed through one or more of the gingerbread cookie panels 330 and/or 350.

The illumination component 400 may be formed from any of a wide variety of translucent materials that enable a light positioned within the illumination component 400 to be used to provide visible light (e.g., white light, or amber light suggestive of the color of candle light or a fireplace fire) to shine through the side panels 430 of the illumination component 400 in a manner that back-lights the decorative markings 444 carried thereon. With the illumination component 400 positioned within the support structure 500 to be overlain by the aperture(s) 545 formed through one or more side panels 530 thereof, and with the gingerbread cookie panels 330 and 350 adhered to corresponding ones of the side panels 530 such that aperture(s) 345 of the gingerbread cookie panels 330 and/or 350 overlie the aperture(s) 545, at least a subset of the backlit decorative markings 444 may become visible through the apertures 545 and 345 such that fictitious windows and/or doors that are decoratively marked on exterior surfaces of the gingerbread structure 1000 are given the appearance of providing a view to a lit interior thereof.

The decorative markings 444 may be printed and/or otherwise formed on external surface(s) of side panel(s) 430 of the illumination component 400. The decorative markings 444 may provide images of candles, a fireplace fire, holiday-related objects (e.g., stockings, presents, etc.), holiday-related decorations (e.g., wreathes, a Christmas tree) and/or religious artifacts (a Menorah), etc. The translucent material of the illumination component 400 may be a sheet of white paper thin enough to allow light to pass through, white translucent plastics material, etc.

In some embodiments, it may be that different versions of decorative markings 444 meant to align with particular aperture(s) 345 of particular gingerbread cookie panels 330 and/or 350 may be printed across multiple ones of the side panels 430 of the illumination component 400 to enable the particular version of decorative markings 444 that are to be visible to be selected by rotating the illumination component 400 relative to the support structure 500 before inserting the illumination component 400 into the support structure 500. In this way a particular view of a fictitious interior of the gingerbread structure 1000 may be selected to be more appropriate for the particular holiday or other occasion for which the gingerbread structure is being built and/or decorated.

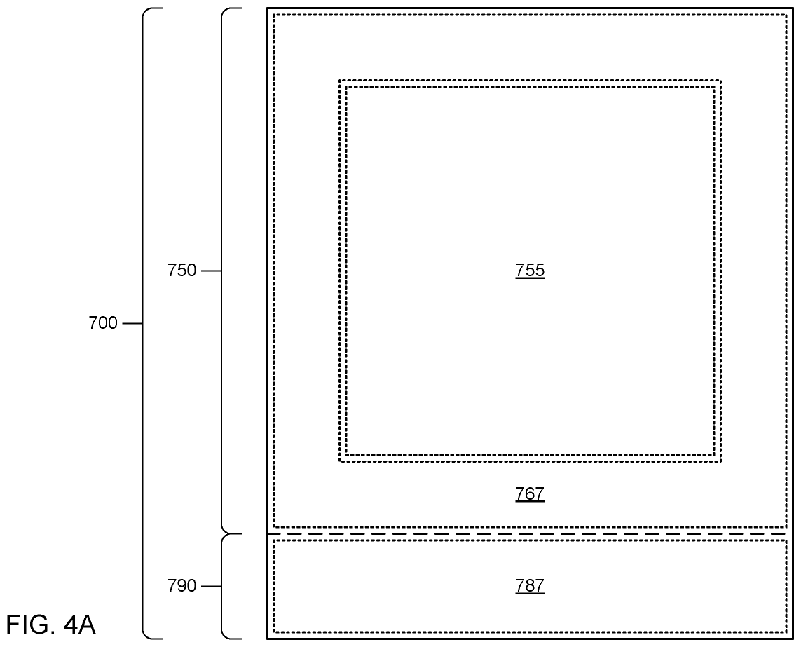

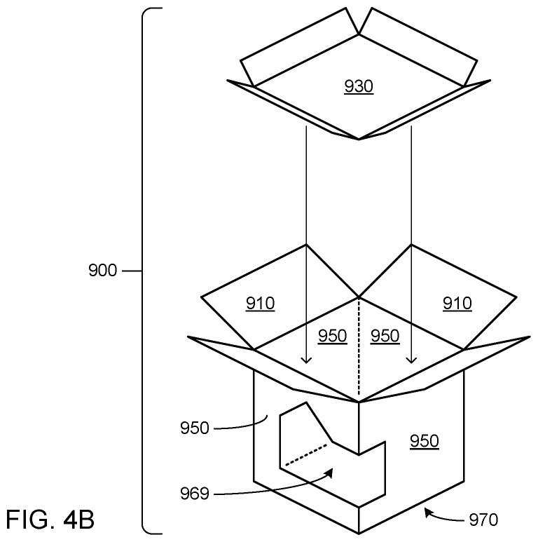

FIGS. 4A through 4B, taken together, depict various aspects of additional components that may serve to provide physical support and/or protection of the gingerbread structure 1000 in at least partially assembled form (i.e., with at least the gingerbread core 300 assembled, even if not decorated).

Turning to FIG. 4A, as has been discussed, the gingerbread core 300 and/or the support structure 500 may be adhered to an upwardly facing surface of the main portion 750 of the base support sheet 700, either during or following assembly of the gingerbread core 300 around and onto the support structure 500, as has been described at length, above. As depicted, there may be a distinct support region 755 defined using various markings (not specifically shown) as the desired location at which the gingerbread core 300 and support structure 500 are to be positioned and/or adhered to the main portion 750. As also depicted, the support region 755 may be positioned toward the center of the main portion 750 so as to cause peripheral portions of the main portion 750 to surround and extended horizontally away from the support region 755. As further depicted, at least one foldable portion 790 (of which, just one is shown) of the base support sheet 700 may be positioned along the outer edge of at least a subset of the peripheral portions of the main portion 750. Each such foldable portion 790 may be joined to the main portion 750 along a fold (depicted with dashed lines) that allows each foldable portion 790 to be moved in a hinge-like manner relative to the main portion 750 (e.g., between at least one possible folded position best seen in FIG. 1A, and an unfolded position best seen in FIG. 1B in which both portions 750 and 790 extend in a single common plane).

As also depicted, a decorative area 767 may be defined to surround the support region 755, and additional decorative area(s) 787 may be defined to cover each foldable portion 790. In some embodiments, within one or more of such decorative areas 767 and/or 787, various decorations may be printed thereon. Thus, such decorations may surround the support region 755. Such printed decorations may include depictions of grass, flowers, plants, trees, farm crops, bundled hay, leaves, holly, mistletoe, pumpkins, snow, animals, a snowman, scarecrows, footprints, boot prints, paw prints, hoof prints, sled tracks, ski tracks, a portion of a road, walkway, sidewalk, brick path, dirt path, stone pavers, an address sign, a street sign, a water well, cartoon characters, gnomes, garden hose, watering can, pink flamingos, yard tools, garden tools, bicycles, tricycles, etc. As a specific example, decorations that include a fictitious walkway leading to a fictitious front door of the gingerbread structure 1000 may be printed (or otherwise formed) within portions of decorative area(s) 767 and/or 787 that extend between an edge of the support region 755 and an outer edge of the base support sheet 750.

Alternatively or additionally, and as previously discussed, embodiments are possible in which the support structure 500 may be formed integrally with the base support sheet 700. In such embodiments, it may be that the portion of such an integrated combination support piece may have the support structure 500 already formed to extend upwards from the upwardly facing surface of the main portion 755 at a location that is pre-positioned within the support region 755. In this way, the use of markings of any type to guide a person to correctly position the support structure 500 within the support region 755 may be entirely obviated.

Turning to FIG. 4B, as has been discussed, the gingerbread structure 1000 may be shipped and/or stored within the box 900 as part of being provided as part of the kit 1900. As depicted, the box 900 may include a viewing window 969 formed through one or more side panels 950 thereof (each side panel 950 serving to provide a side face of the box 900), and where a piece of transparent plastics material may be positioned to enable viewing of at least a portion of the contents of the box 900 without allowing dirt or other contaminants to enter the interior of the box 900. In embodiments in which the kit 1900 is meant to include the gingerbread structure 1000 in an at least partially pre-assembled state (e.g., with the gingerbread core 300 assembled about the support structure 500, as has been described, but maybe not decorated) and/or already adhered to the base support structure 700, then the viewing window 969 may provide a view the at least partially pre-assembled gingerbread structure 1000. Alternatively, in embodiments in which the kit 1900 is meant to include the gingerbread structure 1000 in unassembled form, then the viewing window 969 may provide a view of one or more of the unassembled gingerbread cookie panels 310, 330 and/or 350, and or a view of the one or more packets 100 of edible decorative elements.

As also depicted, the box 900 may include a tray 930 to be included within the box 900 along with the gingerbread structure 1000 in whatever pre-assembled or unassembled form it may be in. More specifically, and especially where the gingerbread structure 1000 is placed within the box 900 in at least partially pre-assembled form, the tray 930 may be positioned within the box 900 to separate the one or more packets 100 of edible decorative elements so as to hold the one or more packets 100 within a particular subpart of the volume of the box 900.

In embodiments in which the gingerbread structure 1000 is to be provided in partially pre-assembled formed in which at least the gingerbread core 300 is pre-assembled, but not yet decorated, the combination of the box 900 (with the tray 930), base support sheet 700 and the support structure 500 may be used in a manner in which they cooperate to protect the pre-assembled gingerbread core 300 from damage during both transport and display in a retail environment. With at least the support structure 500 adhered to (or formed integrally with) the base support sheet 700 such that the pre-assembled gingerbread core 300 is positioned toward the center of the main portion 750 of the base support sheet 700, and with the gingerbread cookie panels 330 and 350 adhered to the support structure 500, the gingerbread core 300 is kept away from inner surfaces of the side panels 950 (that define side faces of the box 900) such that external impacts to the side panels 950 (including the viewing window 969) are prevented from reaching the gingerbread core 300. Also, the gingerbread core 300 is protected from external impacts to the bottom face 970 of the box 900 by the multiple layers of material provided by the combination of portions of the box 970 that form the bottom face 970 (e.g., overlapping box flaps that interact to close the bottom of the box 900) and base support sheet 700. Further, with the tray 930 carrying the one or more packets 100 placed within the box 900, the roof peak ridge defined where the pair of gingerbread cookie panels 310 are adhered to each other is kept away from the top face 910 of the box 900.

1. A gingerbread structure comprising:
at least a first gingerbread cookie panel and a second gingerbread cookie panel;
at least a first amount of edible icing, a second amount of edible icing, and a third amount of edible icing; and
a box-like support structure comprising at least a first side panel and a second side panel that are integrally formed together, wherein:
the first side panel provides a first flat surface;
the second side panel provides a second flat surface;
the first side panel and the second side panel join at a first fold that defines a corner along which the first flat surface and the second flat surface meet at an angle;
an inner surface of the first gingerbread cookie panel is adhered to the first flat surface of the first side panel by the first amount of edible icing in an orientation relative to the first flat surface that causes a first side edge of the first gingerbread cookie panel to extend adjacent to and parallel to the corner; and
an inner surface of the second gingerbread cookie panel is adhered to the second flat surface of the second side panel by the second amount of edible icing in an orientation relative to the second flat surface that causes a second side edge of the second gingerbread cookie panel to extend adjacent to and parallel to the corner, and to extend adjacent to and parallel to the first side edge of the first gingerbread cookie panel to enable the second side edge to be adhered to the first side edge by depositing the third amount of edible icing along and between the first side edge and the second side edge.

2. The gingerbread structure of claim 1, comprising a base support sheet providing an upwardly facing support surface, wherein:
either a downwardly facing flat surface of the box-like support structure is adhered to the upwardly facing support surface, or the box-like support structure is formed integrally with the base support sheet;
the first flat surface extends vertically upwards from the upwardly facing support surface to provide a first wall of the gingerbread structure, and to enable a first bottom edge of the first gingerbread cookie panel to be adhered to the upwardly facing support surface by depositing a fourth amount of edible icing along and between the first bottom edge and the upwardly facing support surface; and
the second flat surface extends vertically upwards from the upwardly facing support surface to provide a second wall of the gingerbread structure, and to enable a second bottom edge of the second gingerbread cookie panel to be adhered to the upwardly facing support surface by depositing a fifth amount of edible icing along and between the second bottom edge and the upwardly facing support surface.

3. The gingerbread structure of claim 2, wherein:
the box-like support structure comprises a bottom panel that provides the downwardly facing flat surface; and
the downwardly facing flat surface is adhered to the upwardly facing support surface of the base support sheet by a sixth amount of edible icing.

4. The gingerbread structure of claim 2, comprising a third gingerbread cookie panel, wherein:
the third gingerbread cookie panel is adhered to a first upper edge of the first gingerbread cookie panel by a sixth amount of edible icing; and
the third gingerbread cookie panel is adhered to a second upper edge of the second gingerbread cookie panel by a seventh amount of edible icing.

5. The gingerbread structure of claim 4, wherein:
the third gingerbread cookie panel provides at least a portion of a roof of the gingerbread structure;
an outwardly facing surface of the third gingerbread cookie panel carries decorative markings thereon; and
the decorative markings comprise at least one of printed markings comprising edible ink, or markings formed in the outwardly facing surface of the third gingerbread cookie panel.

6. The gingerbread structure of claim 2, wherein the upwardly facing surface of the base support sheet caries decorative markings that define a pre-selected part of the upwardly facing support surface as being a support region to guide placement of at least the box-like support structure, with at least both the first gingerbread cookie panel and the second gingerbread cookie panel adhered thereto, onto the support region.

7. The gingerbread structure of claim 1, wherein:
an outwardly facing surface of the first gingerbread cookie panel carries decorative markings thereon; and
the decorative markings comprise at least one of printed markings comprising edible ink, or markings formed in the outwardly facing surface of the first gingerbread cookie panel.

8. The gingerbread structure of claim 1, wherein:
a first aperture is formed through the first gingerbread cookie panel;
the first aperture is shaped and sized to resemble a window of the gingerbread structure;
a second aperture is formed through the first side panel of the box-like support structure; and
the first aperture is positioned on the first gingerbread cookie panel to align with the second aperture to enable light emanating from within the box-like support structure to shine through both the first and second apertures.

9. A kit for at least decorating a gingerbread structure comprising:
a box-like carton having at least four side faces and a bottom face;
a base support sheet providing an upwardly facing support surface; and
a box-like support structure comprising at least a first side panel and a second side panel that are integrally formed together, wherein:
the first side panel provides a first flat surface;
the second side panel provides a second flat surface;
the first side panel and the second side panel join at a first fold that defines a corner along which the first flat surface and the second flat surface meet at an angle;
an inner surface of a first gingerbread cookie panel of the gingerbread structure is adhered to the first flat surface of the first side panel by a first amount of edible icing in an orientation relative to the first flat surface that causes a first side edge of the first gingerbread cookie panel to extend adjacent to and parallel to the corner;
an inner surface of the second gingerbread cookie panel is adhered to the second flat surface of the second side panel by a second amount of edible icing in an orientation relative to the second flat surface that causes a second side edge of the second gingerbread cookie panel to extend adjacent to and parallel to the corner, and to extend adjacent to and parallel to the first side edge of the first gingerbread cookie panel to enable the second side edge to be adhered to the first side edge by depositing the third amount of edible icing along and between the first side edge and the second side edge;
either a downwardly facing flat surface of the box-like support structure is adhered to the upwardly facing support surface, or the box-like support structure is formed integrally with the base support sheet;
the upwardly facing surface of the base support sheet caries decorative markings that define a pre-selected part of the upwardly facing support surface as being a support region to guide placement of at least the box-like support structure, with at least both of the first gingerbread cookie panel and the second gingerbread cookie panel adhered thereto, onto the support region;
the base support sheet is shaped and sized to be placed inside the carton sitting flat atop the bottom face while engaging the four side faces to prevent movement of the base support sheet toward or away from each of the four side faces;
the support region is defined to cause the gingerbread structure to be positioned on the base support sheet at a location away from contact with any of the at least four side faces; and
the support structure, the base support sheet and the carton cooperate to keep the gingerbread structure away from contact with any of the at least four side faces to protect the gingerbread structure from damage caused by impacts against any of the at least four side faces.

10. The kit of claim 9, wherein the gingerbread structure is protected from damage caused by impacts against the bottom face by a combination of material of the bottom face of the carton overlain by the base support sheet.

11. The kit of claim 9, wherein:
the carton comprises a viewing window formed through at least one side face of the at least four side faces to enable viewing of a portion of the gingerbread house from outside the carton; and
the support structure, the base support sheet and the carton cooperate to keep the gingerbread structure away from the viewing window.

12. The kit of claim 11, wherein:
the carton comprises a sheet of transparent plastics material to close the viewing window while also allowing the viewing of a portion of the gingerbread house from outside the carton; and
the support structure, the base support sheet and the carton cooperate to keep the gingerbread structure away from the sheet of transparent plastics material to protect the gingerbread structure from damage caused by impacts against the sheet of transparent plastics material.

13. The kit of claim 11, wherein the viewing window is formed through two adjacent side faces of the at least four side faces at a corner of the carton where the two adjacent side faces meet at another angle.

14. The kit of claim 9, wherein:
the base support sheet comprises a main portion that provides the upwardly facing support surface, and at least one foldable portion;
each foldable portion of the at least one foldable portion is integrally formed with the main portion, and is joined to the main portion along a fold that enables the foldable portion to be moved in a hinge-like manner relative to the main portion between a folded position meeting the main portion at another angle and an unfolded position in which the foldable portion and the main portion extend within a single common plane; and
each foldable portion of the at least one foldable portion is moved to the folded position to extend adjacent to and parallel to one of the side faces of the at least four side faces.

15. The kit of claim 9, wherein:
a first aperture is formed through the first gingerbread cookie panel;
the first aperture is shaped and sized to resemble a window of the gingerbread structure;
a second aperture is formed through the first side panel of the box-like support structure; and
the first aperture is positioned on the first gingerbread cookie panel to align with the second aperture to enable light emanating from within the box-like support structure to shine through both the first and second apertures.
